(19) United States
(12) Patent Application Publication
(10) Pub. No.: US 2007/0265027 A1
(43) Pub. Date: Nov. 15, 2007

(54) Mobile communication device using roller input

(76) Inventor: Chiao-Yu Yu, Taipei (TW)

Correspondence Address: RABIN & Berdo, PC, 1101 14TH STREET, NW, SUITE 500, WASHINGTON, DC, 20005, US

(21) Appl. No.: 11/387,691

(22) Filed: Mar. 24, 2006

(51) Int. Cl. H04M 1/00

(52) U.S. Cl. 455/550.1

(57) ABSTRACT

A mobile communication device using roller input comprising a plurality of roller input units, a plurality of press units, an image extraction unit and a calculation processing unit is provided. Each of the roller input units comprises a plurality of faces, and each face at least has an instruction, and each instruction has a corresponding pit at a predetermined distance. The press unit is electrically connected to the roller input unit to provide a press and generate a press-triggered signal to the image extraction unit, so that a pattern containing the instruction and the pit can be extracted and sent to the calculation processing unit. Thus the predetermined distance between the instruction and the pit is calculated, and the pattern can be converted into an electronic digital signal according to the predetermined distance. Finally, the electronic digital signal, i.e. the user input result, is displayed through the display unit.

### BACKGROUND OF THE INVENTION

1. Field of Invention

The present invention relates to a mobile communication device using roller input, and more particularly to a mobile communication device that replaces keys on the conventional mobile communication device with a roller input manner.

2. Related Art

Following the trend of the integration of 3C and multimedia, the electronic products such as the cell phone, the PDA (Personal Digital Assistant) and the notebook computer all require such a volume size which makes them light, thin, short and small, convenient for use and easy to carry, as well as more intelligent functions. Taking example for the cell phone, it is characterized in personal privacy and portability, and is provided with the function having evolved from the simple call function into the one that integrates the communication function, calculation function, consumer electronics function and commodity function together. Therefore, the cell phone is more than a tool merely for communicating but a tool for exchanging feelings, facilitating travels and work, and mobile entertainment as a private and portable product. As for the PDA, the size thereof at present enables itself to be carried in a pocket, and its convenience can be found in every walk of life and people's lives.

Although the volume size of these electronic devices has become miniaturized increasingly, the functions that they can achieve are enhanced day by day. At present, the design of the portable electronic products has met the demand of practical application from volume to weight. In order to respond to the increasingly miniaturized electronic products, the control core size should be reduced, and the Output/Input device (for example, keys, display screen) must be designed correspondingly to achieve the object of miniaturization in a real sense.

In various types of electronic products, the character or numeral input device and the display are still the most important man-machine interface, but how to reduce the volume size is also the most knotty problem for the designers. Since the conventional mobile communication device uses keys as the input device, and needs more than ten sets of keys, the area occupied by the keys is half of the overall area or more, and thereby it is impossible to achieve the object of miniaturization in a real sense. Furthermore, as numerous keys are needed, the key size is always reduced as much as possible to miniaturize the mobile communication device. However, the size-reduced keys should be operated more carefully, and thus causing much inconvenience. Therefore the input device with touch function is a choice, when the electronic product of this type needs to be miniaturized. Although the touch screen can be operated simply and integrate the display and the keyboard input device as a whole, it is still not suitable to use such input device with touch function when the cost are taken into account.

### SUMMARY OF THE INVENTION

In view of the above problems, the main object of the utility model is to provide a mobile communication device using roller input to resolve the problems exist in the prior art.

In order to achieve the above object, the mobile communication device using roller input disclosed by the present utility model comprises a plurality of roller input units, a plurality of press units, a detection unit, a processing unit and a display unit. The plurality of press units are electrically connected to the plurality of roller input units to facilitate the user to input an instruction by pressing the roller. Each roller input unit comprises a plurality of faces. Each face at least has an instruction and each instruction has a corresponding pit thereon. The press unit generates a press signal to the detection unit when a user presses the roller. Meanwhile, the detection unit, according to the press signal, detects the instruction and the pit position corresponding to the press signal, and outputs the detection signal to the processing unit. The processing unit obtains a data signal corresponding to the detection signal according to detection signal, and the data signal, i.e. the user input result, is displayed through the display unit.

In order to achieve the above object, the present utility model further discloses another mobile communication device using roller input comprising a plurality of roller input units, a plurality of press units, an image extraction unit, a calculation processing unit and a display unit. The plurality of press units are electrically connected to the plurality of roller input units to facilitate the user to input an instruction by pressing the roller. Each roller input unit comprises a plurality of faces. Each face at least has an instruction and each instruction has a corresponding pit at a predetermined distance. The press unit will generate a press-triggered signal to the image extraction unit when a user presses the roller. After receiving the press-triggered signal, the image extraction unit extracts a pattern containing the instruction and the pit so as to output a pattern data to the calculation processing unit. The calculation processing unit calculates the predetermined distance between the instruction and the pit according to the pattern data, and converts the pattern data into an electronic digital signal according to the predetermined distance. And then the electronic digital signal, i.e. the user input result, is displayed through the display unit.

The mobile communication device using roller input disclosed by the present invention is mainly characterized in that it effectively reduces the area of the conventional mobile communication device, which enables the mobile communication device to meet the portability requirement.

The features and examples of the present utility model will be illustrated in the most preferred embodiment in conjunction with figures in detail as below.

### BRIEF DESCRIPTION OF THE DRAWINGS

FIG. 1 is a schematic view of the mobile communication device according to the present invention;

FIG. 2 is a circuit block diagram of the mobile communication device according to the present invention;

FIG. 3 is another circuit block diagram of the mobile communication device according to the present invention;

FIG. 4 is a flowchart of the first embodiment according to the present invention; and

FIG. 5 is a flowchart of the second embodiment according to the present invention.

### DETAILED DESCRIPTION OF THE INVENTION

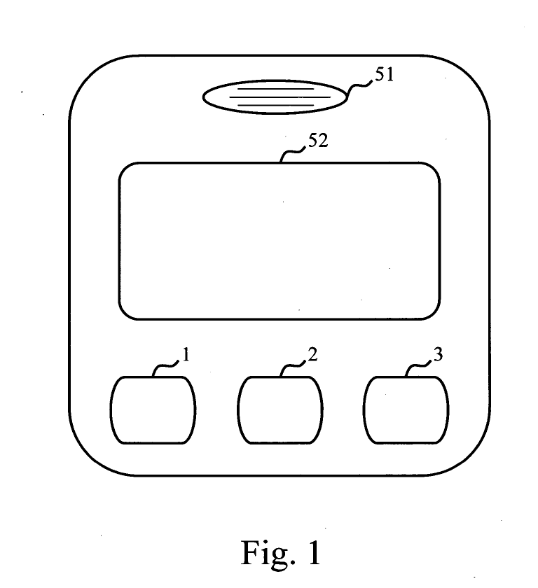

Referring to “FIG. 1”, it is a schematic view of the mobile communication device according to the present invention, which comprises a plurality of roller units 1, 2 and 3, a loudspeaker 51 and a display panel 52. The roller units 1, 2 and 3 are used to replace the keys on the conventional mobile communication device. The input result of the instruction can be displayed through the display panel 52 of the mobile phone or transmitted through the loudspeaker 51 of the mobile phone.

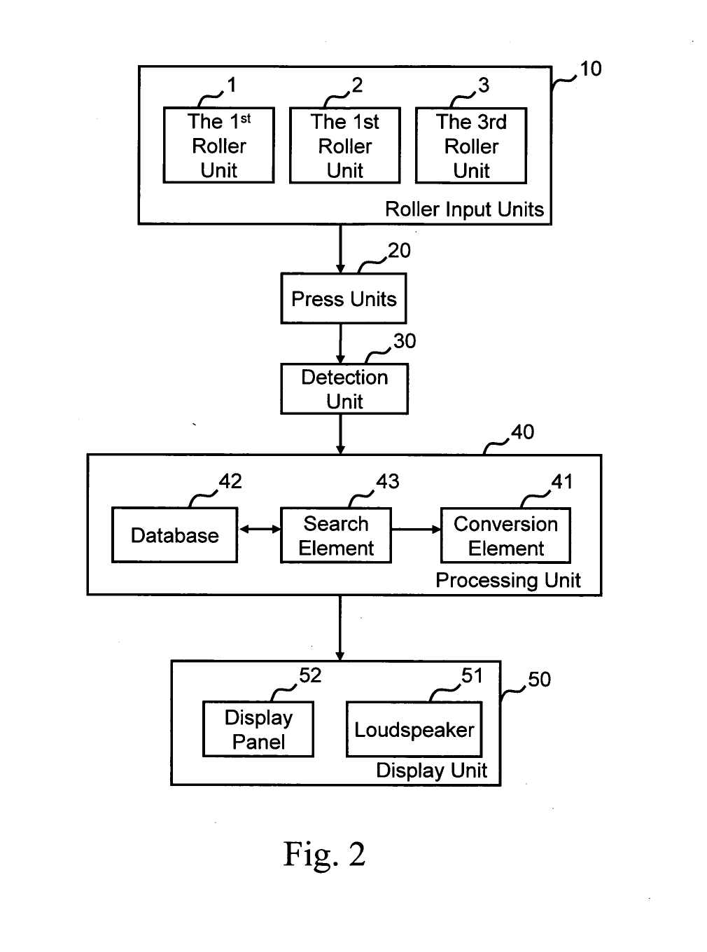

Referring to “FIG. 2”, it is a circuit block diagram of the mobile communication device according to the present invention, which comprises a plurality of roller input units 10, a plurality of press units 20, a detection unit 30, a processing unit 40 and a display unit 50. The plurality of roller input units 10 comprises a first roller unit 1, a second roller unit 2 and a third roller unit 3. The processing unit 40 comprises a conversion element 41, a database 42 and a search element 43. The detailed operation and the connected blocks will be described in the following paragraphs.

The plurality of press units 20 are electrically connected to the plurality of roller input units 10 to provide the function that the user inputs selected instructions, such as inputting a phone number or editing characters, by pressing the roller. Each of the roller input units 1, 2, and 3 comprises a plurality of faces. Each face comprises at least an instruction, and each instruction has a corresponding pit thereon. The instructions can be numerals, characters or other auxiliary symbols. In order to prevent the numerals, characters and other auxiliary symbols from disappearing due to the long-time use, the instructions are made concavely or convexly. The pit corresponding to each instruction can also be made as a land.

The first roller unit 1, the second roller unit 2 and the third roller unit 3 in the plurality of roller input units 10 can perform different function operations respectively. For example, the first roller unit 1 performs the ON/OFF function of the mobile communication device, and the function of selecting the main menu of the mobile communication device; the second roller unit 2 performs the functions of inputting numerals 0-4 and the auxiliary symbol *, and the function of answering a call; and the third roller unit 3 performs the functions of inputting or canceling numerals 5-9 and the auxiliary symbol #, and the function of ending a call. Each of the plurality of roller input units 10 is a 360° rotating roller.

A press signal will be generated to the detection unit 30, when the user presses the roller. At this time, the detection unit 30, according to the press signal, detects the instruction and the pit position corresponding to the press signal, and outputs the detection signal to the processing unit 40.

The processing unit 40 comprises a conversion element 41, a search element 43 and a database 42. The database 42 stores the detection signal represented by the pit position corresponding to the instruction and stores the data signal corresponding to the detection signal. The search element 43 makes a search in the database 42 according to the detection signal so as to output a data signal corresponding to the detection signal. And then the data signal, i.e. the user input result, is displayed through the display panel 52 in the display unit 50. Moreover, the data signal can also be converted into a voice data through the conversion unit 41 in the processing unit 40, and then the voice data is output through the loudspeaker 51 in the display unit 50.

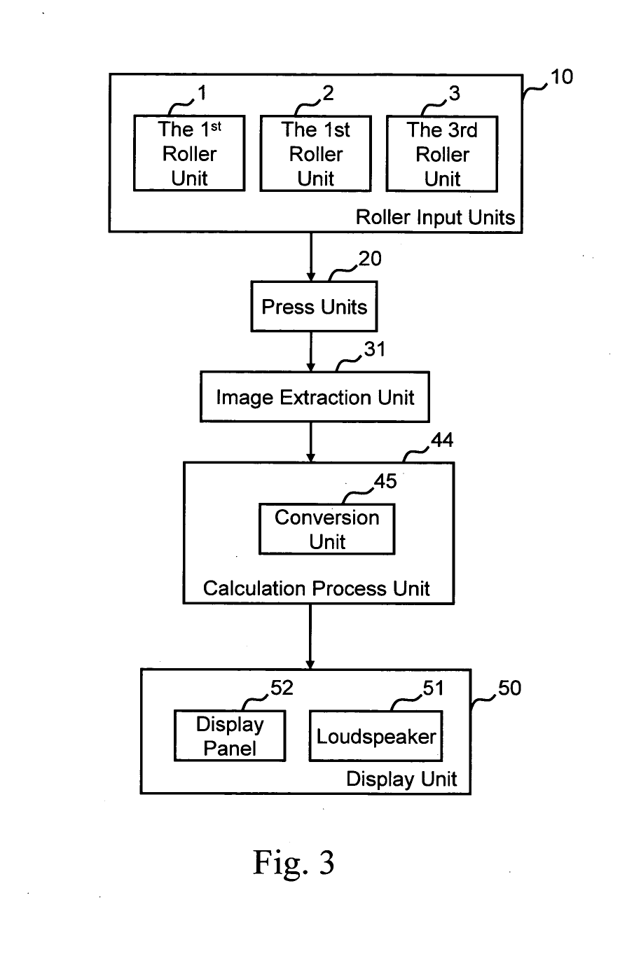

Referring to “FIG. 3”, it is another circuit block diagram of the mobile communication device according to the present invention, with the difference between “FIG. 2” described above in that each instruction on each of the roller input units 1, 2, and 3 has a corresponding pit at a predetermined distance. The mobile communication device of FIG. 3 comprises a plurality of roller input units 10, a plurality of press units 20, an image extraction unit 31, a calculation processing unit 44 and a display unit 50. The plurality of roller input units 10 comprise a first roller unit 1, a second roller unit 2 and a third roller unit 3. The calculation processing unit 44 comprises a conversion element 45. The detailed operation and the connected blocks thereof will be described in the following paragraphs.

The plurality of press units 20 are electrically connected to the plurality of roller input units 10 to provide the function that the user inputs selected instructions, such as inputting a phone number or editing characters, by pressing the roller. Each of the roller input units 1, 2, 3 comprises a plurality of faces. Each face comprises at least an instruction, and each instruction has a corresponding pit thereon at a predetermined distance. For example, the distance between numeral 1 and the corresponding pit is 0.1 cm, and the distance between numeral 2 and the corresponding pit is 0.2 cm. The instructions can be numerals, characters and other auxiliary symbols. In order to prevent the numerals, characters and other auxiliary symbols from disappearing due to the long-time use, the instructions are made concavely or convexly. The pit corresponding to each instruction can also be made as a land.

The first roller unit 1, the second roller unit 2 and the third roller unit 3 in the plurality of roller input units 10 can perform different function operations respectively. For example, the first roller unit 1 performs the ON/OFF function of the mobile communication device and the function of selecting the main menu of the mobile communication device; the second roller unit 2 performs the functions of inputting numerals 0-4 and the auxiliary symbol *, and the function of answering a call; and the third roller unit 3 performs the functions of inputting or canceling numerals 5-9 and the auxiliary symbol #, and the function of ending a call. Each of the plurality of roller input units 10 is a 360° rotating roller.

A press-triggered signal will be generated to the image extraction unit 31 when a user presses the roller. After receiving the press-triggered signal, the image extraction unit 31 starts to extract a pattern containing the instruction and the pit so as to output a pattern data containing the instruction and the pit to the calculation processing unit 44. The image extraction unit 31 is an image sensor or an optical gate electronic device, which is disposed above the roller input unit 10 so as to facilitate the extraction of the pattern containing the instruction and the pit.

The calculation processing unit 44 starts to calculate the predetermined distance between the instruction and the pit in the pattern according to the pattern data containing the instruction and the pit, and converts the pattern data into an electronic digital signal, for example the FPGA (Field Programmable Gate Array) or the neuron circuit, according to the predetermined distance. Then the electronic digital signal, i.e. the input result of the instruction by the user, is displayed through the display panel 52 in the display unit 50. Moreover, the electronic digital signal can be converted into a speech data through the conversion element 45 in the calculation processing unit 44, and then the voice data is output through the loudspeaker 51 in the display unit 50.

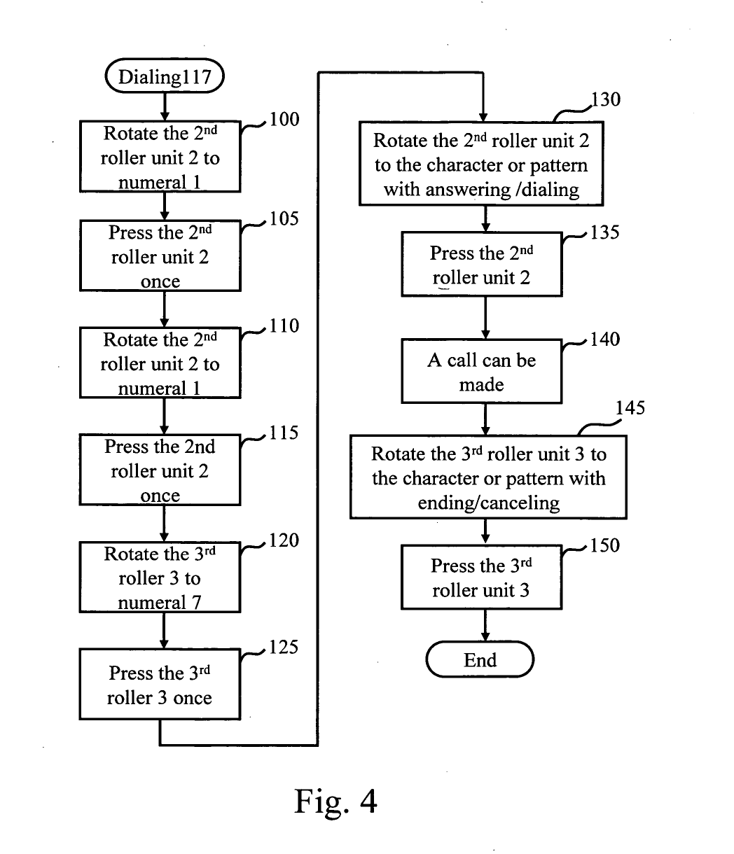

Referring to “FIG. 4”, it is a flowchart of the first embodiment according to the present invention, and the proposed embodiment is illustrated by the example of dialing 117. First, rotate the second roller unit 2 to numeral 1 (step 100) and press once (step 105), and then release, so as to complete the inputting of numeral 1. Subsequently, the second roller unit 2 is rotated to numeral 1 (step 110) and press once again (step 115), and-then release, so as to complete the inputting of numeral 1. And then, rotate the third roller unit 3 to numeral 7 (step 120) and press once (step 125), and then release so as to complete the inputting of numeral 7. Finally, rotate the second roller unit 2 to the character or pattern with answering/dialing (step 130) and press once (step 135), and then release so as to complete dialing. A call can be made by the user (step 140). When the call is over, rotate the third roller unit 3 to the character or pattern with ending/canceling (step 145) and press once on the third roller unit 3 (step 150), and then release so as to complete the ending of a call. Currently, there are phonetic notations on the corresponding numeric keys of the conventional mobile communication device. For example, numeral 1 represents the phonetic notations [symbol] and [symbol] , and so forth. Of course, the mobile communication device of the present invention also has the same function. For example, the second roller unit 2 is rotated to numeral 1 and then pressed, and then the [symbol] and [symbol] can be displayed on the display panel through the software in mobile communication device of the present invention. The user can do edit work by rotating associated with pressing the roller.

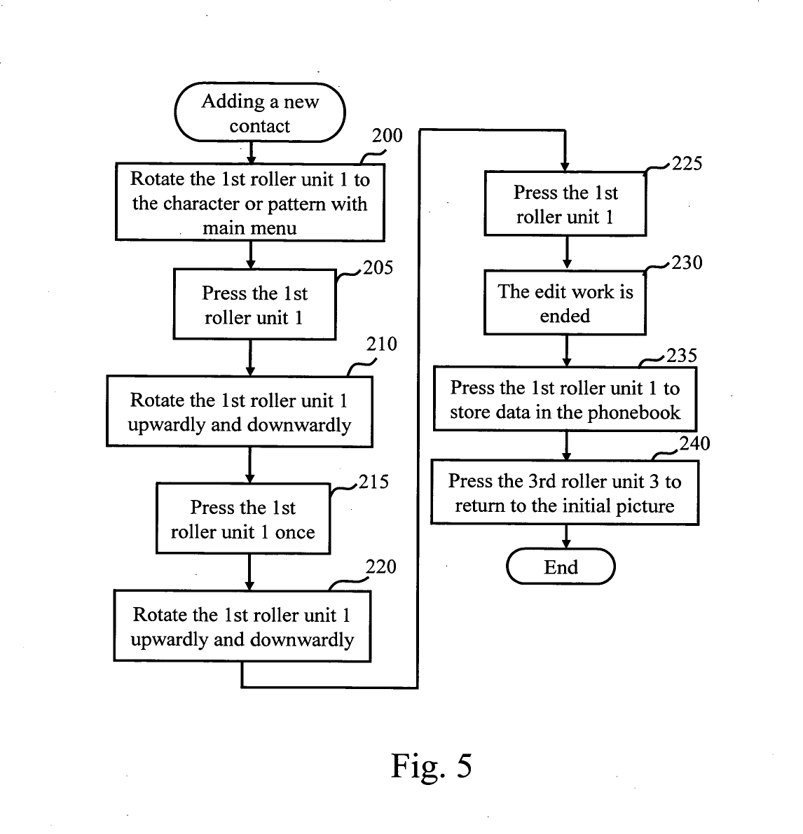

Referring to “FIG. 5”, it is a flowchart of the second embodiment according to the present invention, and the proposed embodiment is illustrated by example of adding a new contact to the phonebook. First, rotate the first roller unit 1 to the character or pattern with main menu (step 200) and press once (step 205), so as to enter the main menu set by the software in the mobile communication device. Subsequently, rotate the first roller unit 1 upwardly and downwardly (step 210); the phonebook function of the main menu is selected and then pressed once (step 215) after the selection so as to complete the operation of selecting the phonebook function. Next, rotate the first roller unit 1 upwardly and downwardly (step 220) to select the add-in the phonebook function, and then after press the first roller unit 1 (step 225), data can be edited through the use of the second roller unit 2 and the third roller unit 3.

Finally, when the edit work is ended (Step 230), the data can then be stored in the phonebook by pressing the first roller unit 1 once (step 235). After the storage, the user can return to the initial picture by pressing the third roller unit 3 once (step 240).

The main object of the mobile communication device using roller input disclosed by the present invention is to effectively reduce the area of the conventional mobile communication device, which enables the mobile communication device to meet the portability requirement.

What is claimed is:

1. A mobile communication device using roller input, comprising:
a plurality of roller input units, each roller input unit including a plurality of faces, each face having at least one instruction, each instruction having a corresponding pit at a predetermined distance;
a plurality of press units, electrically connected to each of the roller input units to generate a press-triggered signal;
an image extraction unit for extracting a pattern containing the instruction and the pit, after receiving the press-triggered signal, so as to output the data of the pattern; and
a calculation processing unit for calculating the predetermined distance between the instruction and the pit according to the data of the pattern, and converting the data of the pattern into an electronic digital signal according to the predetermined distance.

2. The mobile communication device as claimed in claim 1, wherein the calculation processing unit comprises a conversion element for converting the electronic digital signal into a voice signal.

3. The mobile communication device as claimed in claim 1, further comprising a display unit for displaying the electronic digital signal.

4. The mobile communication device as claimed in claim 3, wherein the display unit comprises:
a loudspeaker, electrically connected to the conversion element, for outputting the voice signal; and
a display panel for displaying the electronic digital signal.

5. The mobile communication device as claimed in claim 1, wherein the roller input unit comprises a first roller unit, a second roller unit and a third roller unit.

6. The mobile communication device as claimed in claim 1, wherein the instruction is a plurality of numerals, a plurality of characters or the other auxiliary symbols.

7. The mobile communication device as claimed in claim 1, wherein the instructions are made concavely.

8. The mobile communication device as claimed in claim 1, wherein the instructions are made convexly.

9. The mobile communication device as claimed in claim 1, wherein the roller input unit is a 360° rotating roller.

10. A mobile communication device using roller input, comprising:
a plurality of roller input units, each roller input unit including a plurality of faces, each face having at least one instruction, each instruction having a corresponding pit;
a plurality of press units, electrically connected to each of the roller input units to generate a press signal;
a detection unit for detecting the instruction and the pit position corresponding to the press signal so as to output a detection signal; and
a processing unit for obtaining a data signal corresponding to the pit position of the instruction according to the detection signal.

11. The mobile communication device as claimed in claim 10, further comprising a display unit for displaying the data signal.

12. The mobile communication device as claimed in claim 11, wherein the display unit comprises:
a loudspeaker, electrically connected to the conversion element, for outputting the voice signal; and
a display panel for displaying the data signal.

13. The mobile communication device as claimed in claim 10, wherein the roller input unit comprises a first roller unit, a second roller unit and a third roller unit.

14. The mobile communication device as claimed in claim 10, wherein the instruction is a plurality of numerals, a plurality of characters or the other auxiliary symbols.

15. The mobile communication device as claimed in claim 10, wherein the instructions are made concavely.

16. The mobile communication device as claimed in claim 10, wherein the instructions are made convexly.

17. The mobile communication device as claimed in claim 10, wherein the roller input unit is a 360° rotating roller.

18. The mobile communication device as claimed in claim 10, wherein the processing unit comprises:
a database for storing the detection signal represented by the pit position corresponding to the instruction and the data signal corresponding to the detection signal;
a search element for searching in the database according to the detection signal so as to output the data signal; and
a conversion element for converting the data signal into a voice signal.
